(19) United States
(12) Patent Application Publication
(10) Pub. No.: US 2019/0356186 A1
(43) Pub. Date: Nov. 21, 2019

(54) ROTOR AND MOTOR

(71) Applicant: Nidec Corporation, Kyoto (JP)

(72) Inventors: Akira ICHIEN, Kyoto (JP); Shunsuke MURAKAMI, Kyoto (JP)

(21) Appl. No.: 16/474,233

(22) PCT Filed: Dec. 22, 2017
(86) PCT No.: PCT/JP2017/046060

§ 371 Date: Jun. 27, 2019

(30) Foreign Application Priority Data
Dec. 28, 2016 (JP) 2016-257148

(51) Int. Cl. H02K 1/27; H02K 16/02

(52) U.S. Cl. CPC H02K 1/2773; H02K 5/1737; H02K 16/02

(57) ABSTRACT

A rotor includes a first rotating body and a second rotating body. The first rotating body includes a first rotor core, first magnets arranged in a circumferential direction, and first outer side surfaces arranged in the circumferential direction. Each of the first outer side surfaces is an outer side surface of the first magnet or an outer side surface of the first rotor core, and includes a first circular arc surface curved in a circular arc shape with a first curvature radius and arranged on one side in the circumferential direction and a second circular arc surface curved in a circular arc shape with a second curvature radius and arranged on the other side in the circumferential direction. The second rotating body is the same as the first rotating body, and a second outer side surface is an outer side surface of a second magnet or an outer side surface of a second rotor core, and includes a third circular arc surface curved in a circular arc shape with a third curvature radius and arranged on one side in the circumferential direction and a fourth circular arc surface curved in a circular arc shape with a fourth curvature radius and arranged on the other side in the circumferential direction.

### CROSS REFERENCE TO RELATED APPLICATIONS

This is the U.S. national stage of PCT Application No. PCT/JP2017/046060, filed on Dec. 22, 2017, and priority under 35 U.S.C. § 119(a) and 35 U.S.C. § 365(b) is claimed from Japanese Application No. 2016-257148, filed Dec. 28, 2016; the entire disclosures of which are incorporated herein by reference.

### 1. FIELD OF THE INVENTION

The present disclosure relates to a rotor and a motor.

### 2. BACKGROUND

Conventionally, various configurations have been adopted to generate stable torque while driving a motor. Particularly, in recent years, there is also a demand for a motor having stable torque. In order to meet such a demand, a configuration in which pulsating torque is reduced has been adopted in a conventional rotor used in a motor. For example, a related art discloses a configuration in which a convex portion of a rotor in an outside of a magnet having a flat plate shape is provided with an outer circumference obtained by combining a first circular arc and a second circular arc having a curvature radius different from that of the first circular arc.

However, in the rotor of the above-described configuration, there was a case in which torque ripples may not be sufficiently reduced in response to a demand for a further reduction of the torque ripples in recent years.

### SUMMARY

According to an example embodiment of the present disclosure, a rotor includes a first rotating body and a second rotating body arranged along a central axis extending in a vertical direction. The first rotating body includes a first rotor core having a cylindrical shape with the central axis as a center thereof, a plurality of first magnets arranged in a circumferential direction, and a plurality of first outer side surfaces arranged in the circumferential direction. Each of the first outer side surfaces is an outer side surface of the first magnet or an outer side surface of the first rotor core, and includes a first circular arc surface curved in a circular arc shape with a first curvature radius in a plan view and arranged on one side in the circumferential direction and a second circular arc surface curved in a circular arc shape with a second curvature radius different from the first curvature radius in a plan view and arranged on the other side in the circumferential direction. The second rotating body is positioned on a side lower the first rotating body in an axial direction, and includes a second rotor core having a cylindrical shape with the central axis as a center thereof, a plurality of second magnets arranged in the circumferential direction, and a plurality of second outer side surfaces arranged in the circumferential direction. Each of the second outer side surfaces is an outer side surface of the second magnet or an outer side surface of the second rotor core, and includes a third circular arc surface curved in a circular arc shape with a third curvature radius in a plan view and arranged on one side in the circumferential direction and a fourth circular arc surface curved in a circular arc shape with a fourth curvature radius different from the third curvature radius in a plan view and arranged on the other side in the circumferential direction.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an external perspective view of a motor according to an example embodiment of the present disclosure.

FIG. 2 is a cross-sectional view of a motor according to an example embodiment of the present disclosure.

FIG. 3 is an external perspective view of a rotor according to an example embodiment of the present disclosure.

FIG. 4 is a plan view of a magnet according to an example embodiment of the present disclosure.

FIG. 5 is an external perspective view of a rotor of a modified example embodiment of the present disclosure.

### DETAILED DESCRIPTION

Hereinafter, example embodiments and modified examples of the present disclosure will be described with reference to the drawings. However, the example embodiments and the modified examples described below are merely examples of the present disclosure and are not intended to be construed as limiting the technical scope of the present disclosure. In each drawing, when the same components are denoted by the same reference numerals, the description thereof may be omitted.

In the following description, a central axis of rotation of a rotor in a motor is defined as “C”. The direction in which the central axis C extends is defined as a “vertical direction”. However, the vertical direction in the present specification is a term used merely for the purpose of explanation and does not limit an actual positional relationship or direction. That is, a gravity direction is not necessarily a downward direction. Further, in the present specification, a direction parallel to a rotation axis of the motor is referred to as an “axial direction”, a direction orthogonal to the rotation axis of the motor is referred to as a “radial direction”, and a direction along a circular arc about the rotation axis of the motor is referred to as a “circumferential direction”, respectively.

Further, in the present specification, “extending in the axial direction” includes a state of extending in a direction inclined in a range of fewer than 45 degrees with respect to the axial direction in addition to a state of strictly extending in the axial direction. Likewise, in the present specification, “extending in the radial direction” includes a state of extending in a direction inclined in a range of fewer than 45 degrees with respect to the radial direction in addition to a state of strictly extending in the radial direction. Further, the term “straight line” includes a straight line segment without unevenness, and also a line segment with some unevenness or curvature. Also, the term “the same” or “equal” includes not only a component which is completely the same but also a component having some difference in a degree sufficient to achieve the gist of the present disclosure.

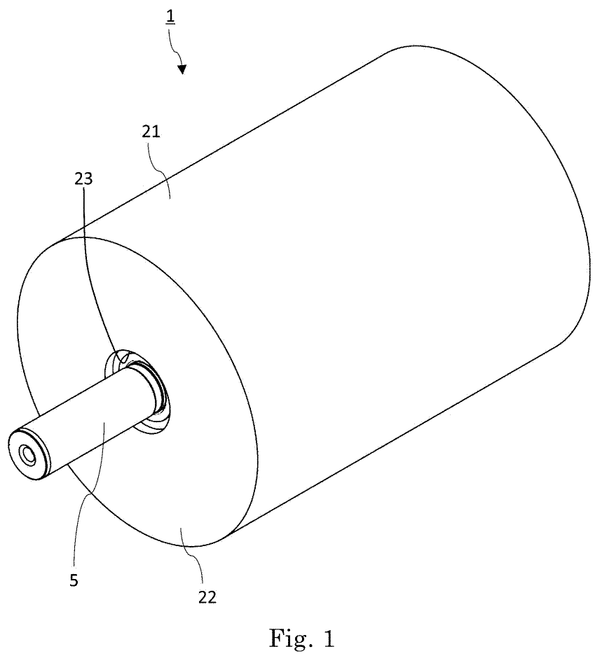

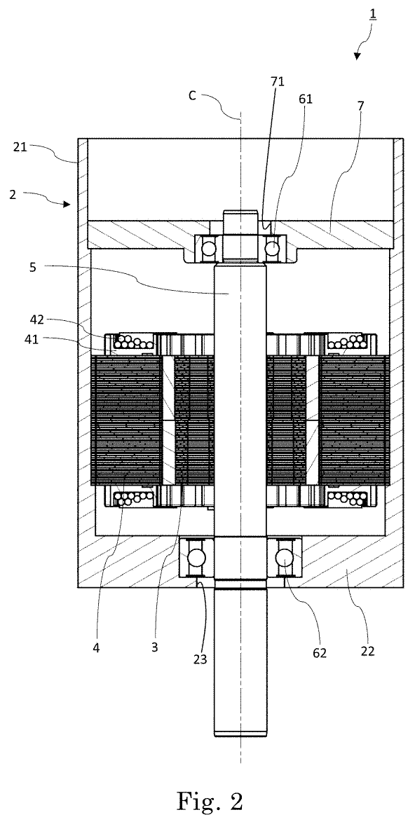

A motor of the present example embodiment is used as, for example, a motor for electric power steering. FIG. 1 is an external perspective view of a motor 1 of the present example embodiment. FIG. 2 is a cross-sectional view of the motor 1. As shown in FIGS. 1 and 2, the motor 1 includes a housing 2, a rotor 3, a stator 4, a shaft 5, an upper bearing 61, a lower bearing 62, and a bearing holder 7. As shown in FIG. 1, a housing cylinder 21, a housing bottom 22, and the shaft 5 are visually recognized from the outside.

As shown in FIG. 2, the housing 2 includes the housing cylinder 21 and the housing bottom 22. The housing 2 is made of a conductive material such as metal. The housing 2 accommodates the rotor 3, the stator 4, the shaft 5, the upper bearing 61, the lower bearing 62, and the bearing holder 7. Here, the term “accommodate” includes both a case in which the whole of an object to be accommodated is positioned inside the housing and a case in which a part of the object to be accommodated is positioned inside the housing. The housing 2 is open upward.

The housing cylinder 21 has a cylindrical shape with a central axis C as a center thereof. The bearing holder 7 having a substantially circular plate shape is disposed in the housing cylinder 21. An inner circumferential surface of the housing cylinder 21 is in contact with an outer circumferential surface of the bearing holder 7 and an outer circumferential surface of the stator 4. The housing cylinder 21 is fixed to the bearing holder 7 and the stator 4.

Further, the housing cylinder 21 may not necessary have the cylindrical shape and may have any shape such as a box shape as long as the stator 4 and the bearing holder 7 can be fixed to the inner circumferential surface thereof. Further, the housing cylinder 21 may have a shape combining a cylindrical shape and other shapes such as a box shape. The inner circumferential surface of the housing cylinder 21 may not be in contact with the stator 4 and the bearing holder 7 on the entire circumference, and only a part of the inner circumferential surface may be in contact with the stator 4 and the bearing holder 7. Further, it is not necessarily to have a configuration in which the housing cylinder 21 and the bearing holder 7 are in contact with each other, and for example, a configuration may be adopted in which the bearing holder 7 is disposed on an upper side of the housing cylinder 21. In other words, the housing 2 may not necessarily accommodate the bearing holder 7.

The housing bottom 22 is disposed below the stator 4. The housing bottom 22 supports the lower bearing 62. The housing bottom 22 includes an output shaft hole 23 which passes through the housing bottom 22 in an axial direction and through which the shaft 5 is inserted and passed.

Further, in the present example embodiment, the housing 2 is a separate member from the bearing holder 7. The housing cylinder 21 and the bearing holder 7 may be a single member, and the housing bottom 22 may be a separate member. Further, each of the housing cylinder 21, the housing bottom 22, and the bearing holder 7 may be a separate member.

The bearing holder 7 has a circular plate shape. The bearing holder 7 is disposed above the stator 4. The bearing holder 7 includes an opening 71 around the central axis C. The opening 71 is a through-hole passing through the bearing holder 7 in the axial direction. At least a part of the shaft 5 is positioned on an inner side of the opening 71. The bearing holder 7 supports the upper bearing 61. The outer circumferential surface of the bearing holder 7 is in contact with the inner circumferential surface of the housing cylinder 21, and the bearing holder 7 is fixed to the housing cylinder 21. In the present example embodiment, the bearing holder 7 is fixed to the housing cylinder 21 by shrink fitting. Further, the bearing holder 7 may be fixed to the housing cylinder 21 by other methods such as press fitting.

The stator 4 is disposed inside the housing 2 and outside the rotor 3 in a radial direction so as to face the rotor 3. That is, the stator 4 surrounds the rotor 3 in a circumferential direction. The stator 4 includes a stator core (not shown), an insulator 41, and a coil 42. The stator core is formed of a laminated steel plate in which electromagnetic steel plates are laminated in the axial direction. In the present example embodiment, the stator core has an annular shape with the central axis C as a center thereof. The insulator 41 is formed of an insulator such as resin and attached to the stator core. The coil 42 is formed by a conducting wire wound around the stator core through the insulator 41. The outer circumferential surface of the stator 4 is fixed to an inner circumferential surface of the housing 2.

The upper bearing 61 and the lower bearing 62 of the motor 1 are ball bearings. The upper bearing 61 and the lower bearing 62 rotatably support the shaft 5 in the circumferential direction with the central axis C as a center thereof. The upper bearing 61 is supported by the bearing holder 7. The lower bearing 62 is supported by the housing bottom 22. The upper bearing 61 and the lower bearing 62 may be other types of bearings than ball bearings.

In the present specification, the upper bearing 61 and the lower bearing 62 are collectively referred to as “bearings”. That is, the bearings, which include the upper bearing 61 and the lower bearing 62, rotatably support the shaft 5 and the rotor 3.

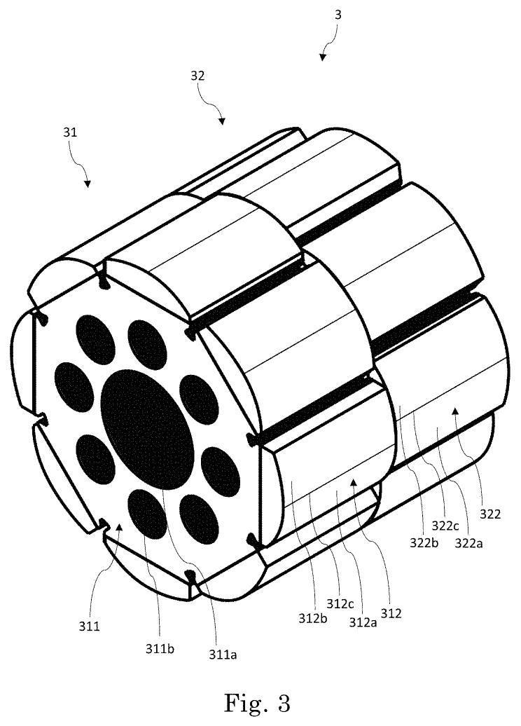

The rotor 3 is arranged along the central axis C extending in a vertical direction and is attached to an outer circumference of the shaft 5. FIG. 3 is a perspective view of the rotor 3 of the present example embodiment.

As shown in FIG. 3, the rotor 3 includes a first rotating body 31 and a second rotating body 32 arranged along the central axis C. The first rotating body 31 is positioned above the second rotating body 32 in the axial direction, and the second rotating body 32 is positioned below the first rotating body 31 in the axial direction. The first rotating body 31 and the second rotating body 32 may be in contact with each other or may be slightly separated from each other. However, when each of the first rotating body 31 and the second rotating body 32 is held by a holder, the first rotating body 31 and the second rotating body 32 may necessarily be separated by the holder.

Since the first rotating body 31 and the second rotating body 32 have similar configurations, there is a case in which the first rotating body 31 is described and the second rotating body 32 is not described for the configuration and function common to the first rotating body 31 and the second rotating body 32. Further, in the rotor 3, a plan view of the first rotating body 31 viewed from an upper side in the axial direction and a plan view of the second rotating body 32 viewed from a lower side in the axial direction are the same.

The first rotating body 31 and the second rotating body 32 include a first rotor core 311 and a second rotor core (not shown), respectively. The first rotating body 31 and the second rotating body 32 include a first magnet 312 and a second magnet 322, respectively. The first rotating body 31 and the second rotating body 32 are disposed such that the first rotor core 311 and the first magnet 312, and the second rotor core and the second magnet 322 face each other in the axial direction.

The first rotor core 311 of the first rotating body 31 includes a shaft through hole 311a at a position including the central axis C. The first rotor core 311 of the first rotating body 31 includes a plurality of through holes 311b outside the shaft through hole 311a in the radial direction. The number of the plurality of through holes 311b is eight, which is the same as the number of circumferential surfaces of the first rotor core 311. The first rotor core 311 has a cylindrical shape, for example, a polygonal prism shape. A cross section of the first rotor core 311 in a plane perpendicular to the axial direction has, for example, a polygonal shape such as a regular octagonal shape. However, the first rotor core 311 is not necessarily limited to the polygonal prism shape and may have a cylindrical shape or other shapes.

In the first rotating body 31, a plurality of first magnets 312 arranged in the circumferential direction are disposed on an outer circumferential surface of the first rotor core 311. As shown in FIG. 3, the plurality of first magnets 312 are disposed on a planar portion of an outer circumference of the first rotor core 311 having a polygonal shape. In the rotor 3 of FIG. 3, the number of the first magnets 312 is eight. Likewise, in the second rotating body 32, a plurality of second magnets 322 arranged in the circumferential direction are disposed on an outer circumferential surface of the second rotor core. The number of the first magnets 312 is the same as that of the second magnets 322. That is, the number of the second magnets 322 is eight.

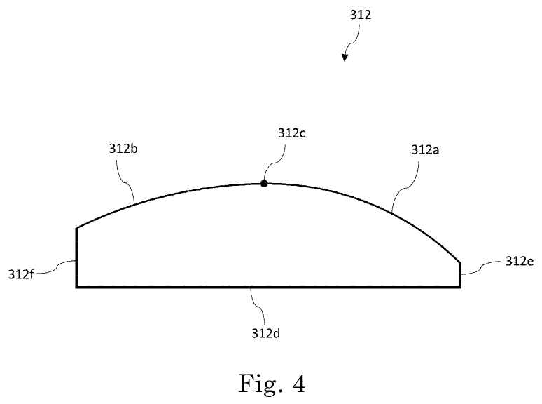

FIG. 4 is a cross-sectional view of the first magnet 312 in a plane orthogonal to the axial direction. As shown in FIG. 4, the first magnet 312 includes a first circular arc surface 312a and a second circular arc surface 312b on a first outer side surface in an outside thereof in the radial direction. The first circular arc surface 312a and the second circular arc surface 312b face an inner circumferential surface of the stator 4. In the rotor 3 of the present example embodiment, a central portion of the first outer side surface of the first magnet 312 in the circumferential direction is a first top portion 312c of a first outer circumferential surface, which is the farthest from a first inner side surface 312d. In the first outer side surface, the first circular arc surface 312a is arranged on one side in the circumferential direction with respect to the first top portion 312c, and the second circular arc surface 312b is arranged on the other side in the circumferential direction with respect to the first top portion 312c. The first circular arc surface 312a and the second circular arc surface 312b are curved in a circular arc shape to have a first curvature radius R1 and a second curvature radius R2, respectively. The first curvature radius R1 and the second curvature radius R2 are curvature radii different from each other.

The first magnet 312 includes the first inner side surface 312d on an inner side in the radial direction and first connection surfaces 312e and 312f on side surfaces of both sides in the circumferential direction. The first inner side surface 312d is in contact with the outer circumferential surface of the first rotor core 311. A cross section of the first inner side surface 312d is formed as a straight line. The first inner side surface 312d is connected to the outer circumferential surface of the first rotor core 311 by being adhered by an adhesive. Also, a connector may be used instead of the adhesive.

Each of the first connection surfaces 312e and 312f is formed as a straight line and positioned between outer side surfaces of the first magnets 312 arranged adjacent to each other in the circumferential direction. The first connection surfaces 312e and 312f of the first magnets 312 disposed adjacent to each other are spaced apart from each other. As shown in FIG. 4, lengths of the first connection surfaces 312e and 312f are different from each other.

Like the first magnet 312, the second magnet 322 include a third circular arc surface 322a and a fourth circular arc surface 322b on a second outer side surface in an outside thereof in the radial direction. In the rotor 3 of the present example embodiment, a central portion of the second magnet 322 in the circumferential direction is a second top portion 322c of a second outer circumferential surface, which is the farthest from a second inner side surface 322d. In the second outer side surface, the third circular arc surface 322a is arranged on one side in the circumferential direction with respect to the second top portion 322c, and the fourth circular arc surface 322b is arranged on the other side in the circumferential direction with respect to the second top portion 322c. The third circular arc surface 322a and the fourth circular arc surface 322b are curved in a circular arc shape to have a third curvature radius R3 and a fourth curvature radius R4, respectively. The third curvature radius R3 and the fourth curvature radius R4 are curvature radii different from each other.

Accordingly, the rotor 3 has the first curvature radius R1 of the first circular arc surface 312a, the second curvature radius R2 of the second circular arc surface 312b, the third curvature radius R3 of the third circular arc surface 322a, and the fourth curvature radius R4 of the fourth circular arc surface 322b. Thus, in the motor 1 including the rotor 3, a design may be provided in which phases of torque ripples included in the torque generated from the first circular arc surface 312a, the second circular arc surface 312b, the third circular arc surface 322a, and the fourth circular arc surface 322b cancel each other out. Accordingly, the torque ripples generated while the motor 1 including the rotor 3 rotates may be reduced.

Positions of the first rotating body 31 and the second rotating body 32 in the circumferential direction are deviated from each other. In other words, a positional deviation of the first rotating body 31 with respect to the second rotating body 32 in the circumferential direction in one rotational direction of the rotor 3 is smaller than the positional deviation of the first rotating body 31 with respect to the second rotating body 32 in the circumferential direction in another rotational direction of the rotor 3. Accordingly, positions of the shaft through hole 311a of the first rotor core 311 and a shaft through hole of the second rotor core overlap when viewed from the axial direction. The shaft 5 is inserted into the shaft through holes. Meanwhile, the through holes 311b may not necessarily overlap each other in the first rotating body 31 and the second rotating body 32 when viewed from the axial direction. Further, the first top portion 312c of the first magnet 312 of the first rotating body 31 and the second top portion 322c of the second magnet 322 of the second rotating body 32 are at different positions in the circumferential direction. Cogging torque generated while the motor 1 including the rotor 3 rotates may be suppressed by such a configuration. Further, since a configuration may be provided in which the phases of the torque ripples included in the torque generated from the first circular arc surface 312a, the second circular arc surface 312b, the third circular arc surface 322a, and the fourth circular arc surface 322b cancel each other out easily, the torque ripples may be reduced more effectively.

Meanwhile, a rotating body having an outer side surface with a small curvature radius has low cogging torque and excellent robustness. Thus, by disposing rotating bodies having outer side surfaces with a small curvature radius on one side in the circumferential direction in a rotational direction, a configuration having low cogging torque and excellent robustness may be provided.

In the first rotating body 31 and the second rotating body 32 which are closer to each other in one rotational direction of the rotor 3, the first rotating body 31 is at a front position in the circumferential direction, and the second rotating body 32 is at a rear position in the circumferential direction. That is, the first magnet 312 of the first rotating body 31 is one side in the circumferential direction with respect to the second magnet 322 of the second rotating body 32. In other words, the second magnet 322 of the second rotating body 32 is the other side in the circumferential direction with respect to the first magnet 312 of the first rotating body 31.

Further, when the rotor 3 rotates, the first magnet 312 or the second magnet 322 reaching a predetermined position in the circumferential direction first is referred to as “one side” in the circumferential direction, and the first magnet 312 or the second magnet 322 subsequently reaching the predetermined position in the circumferential direction is referred to as “the other side” in the circumferential direction. The same applies to the first circular arc surface 312a to the fourth circular arc surface 322b. Further, in the present specification, for convenience of description, a predetermined angle at which the second rotating body 32 deviates to one side in the circumferential direction with respect to the first rotating body 31 is referred to as an “advance side”, and a predetermined angle deviated to the other side in the circumferential direction is referred to as a “retard side”.

In one rotational direction of the rotor 3, the first circular arc surface 312a is one side in the circumferential direction with respect to the second circular arc surface 312b, and the third circular arc surface 322a is one side in the circumferential direction with respect to the fourth circular arc surface 322b. On the contrary, in another rotational direction of the rotor 3, the fourth circular arc surface 322b is one side in the circumferential direction with respect to the third circular arc surface 322a, and the second circular arc surface 312b is one side in the circumferential direction with respect to the first circular arc surface 312a.

Thus, a configuration in which the cogging torque is relatively small may be provided by making the first curvature radius R1 of the first circular arc surface 312a smaller than the second curvature radius R2 of the second circular arc surface 312b in one rotational direction. Also, the torque ripples may be reduced effectively in one rotational direction.

Further, in another rotational direction opposite to the above, a configuration in which the cogging torque is relatively small in the other rotational direction may be provided by making the fourth curvature radius R4 of the fourth circular arc surface 322b smaller than the third curvature radius R3 of the third circular arc surface 322a. Also, the torque ripples may be reduced effectively in the other rotational direction.

Further, a configuration in which the cogging torque and the torque ripples are reduced to the same extent in both of the one rotational direction and the other rotational direction may be provided by making the first curvature radius R1 equal to the fourth curvature radius R4, and the second curvature radius R2 equal to the third curvature radius R3. That is, regardless of the rotational direction, torque with reduced cogging torque and torque ripples may be generated in the same manner.

Further, a certain effect is obtained even when individually applying the conditions on the curvature radii of the circular arc surfaces, and a better effect may be obtained by combining each other.

Further, the first magnet 312 may have a shape including the first outer side surface having the first circular arc surface 312a and the second circular arc surface 312b and the first inner side surface 312d, but not including the first connection surfaces 312e and 312f. The same applies to the second magnet 322.

Further, when the outer circumferential surface of the first rotor core 311 has a curved shape such as a cylindrical shape, the first inner side surface 312d of the first magnet 312 may not be formed as a straight line but may have a form curved along the outer circumferential surface of the first rotor core 311 such as an arcuate shape or the like. Also, the first inner side surface 312d may have a shape having a linear portion and a curved portion. The same applies to the second magnet 322.

When the motor 1 operates, the coil 42 is energized by power supplied from the outside, and torque in the circumferential direction is generated between the stator 4 and the rotor 3 by a magnetic force and an electromagnetic force. By this torque, the rotor 3 rotates relatively with respect to the stator 4 about the central axis C. When the rotor 3 rotates with respect to the stator 4, the shaft 5 to which the rotor 3 is attached rotates, and driving power is output from an output terminal of the shaft 5.

When the motor 1 of the conventional configuration rotates, cogging torque may be generated depending on a rotation angle of the rotor 3 with respect to the stator 4, and thus there is a case in which it is difficult to rotate smoothly. Also, there is a case in which the generated torque may include ripples, and thus the torque may not be stable.

On the other hand, in the rotor 3, the first outer side surface of the first rotating body 31 includes the first circular arc surface 312a and the second circular arc surface 312b having curvature radii different from each other, and the second outer side surface of the second rotating body 32 includes the third circular arc surface 322a and the fourth circular arc surface 322b having curvature radii different from each other. Thus, it is possible to design such that the phases of the torque ripples generated in the first circular arc surface 312a to the fourth circular arc surface 322b cancel each other out. For example, by making the phases of the torque ripples generated in the first rotating body 31 and the second rotating body 32 opposite to each other, the torque ripples of the first rotating body 31 and the second rotating body 32 may be canceled. That is, a configuration may be provided in which the torque ripples generated while driving the motor 1 including the rotor 3 are reduced.

Further, in the rotor 3, since the first rotating body 31 is deviated from the second rotating body 32 in the circumferential direction, the cogging torque generated while driving the motor 1 including the rotor 3 may be reduced. Also, since it is easy to design to have a phase relationship in which the torque ripples generated in the first circular arc surface 312a to the fourth circular arc surface 322b cancel each other out, a configuration may be provided in which the torque ripples are reduced more effectively.

The motor 1 is not limited to the above-described example embodiment, and various forms that can be considered from the above-described example embodiment are also included. For example, the motor 1 may be configured as modified examples below. In the modified examples below, descriptions of the same configurations and functions as those of the example embodiment will be omitted, and differences from the example embodiment will be mainly described. Further, in a configuration having a plurality of rotating bodies, a description about one rotating body may be given, and a description of other rotating bodies may be omitted for the portions having the features common to the rotating bodies.

The rotor of the present disclosure may be applied not only to a so-called surface permanent magnet (SPM) motor as in the example embodiment but also to a so-called inner permanent magnet (IPM) motor as in the present modified example. A rotor 3a of the present modified example is a rotor used for a so-called IPM motor. Although a specific description will be given below, descriptions of the same configurations and functions as those of the example embodiment will be omitted.

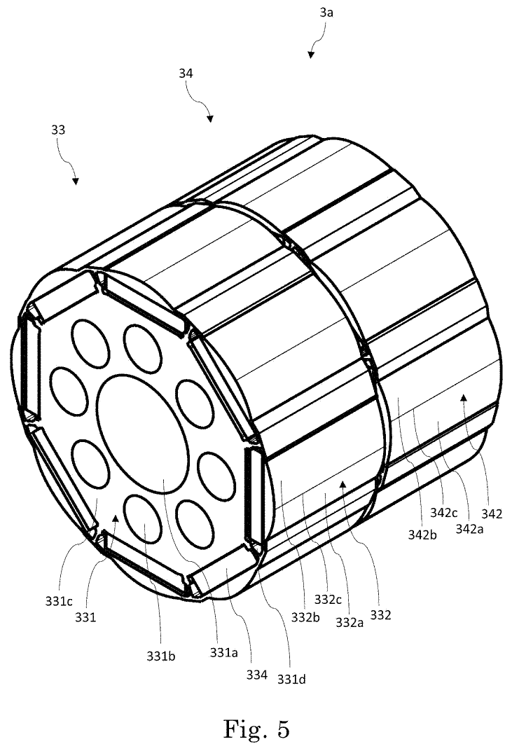

FIG. 5 is a perspective view of the rotor 3a in one modified example according to the present disclosure. As shown in FIG. 5, the rotor 3a of the present modified example includes two rotating bodies, that is, a first rotating body 33 and a second rotating body 34, arranged along a central axis C. The first rotating body 33 is positioned above the second rotating body 34 in an axial direction, and the second rotating body 34 is positioned below the first rotating body 33 in the axial direction.

The first rotating body 33 includes a cylindrical-shaped first rotor core 331 with the central axis C as a center thereof and first magnets 334.

The first rotor core 331 includes a shaft through hole 331a at a position including the central axis C. The first rotor core 331 of the first rotating body 33 includes a plurality of through holes 331b on an outside of the shaft through hole 331a in a radial direction. The first rotor core 331 includes a first inner side core 331c, a first outer side core 332, and a first connection portion 331d. The first inner side core 331c is positioned further inward than the first magnets 334 in the radial direction. The first outer side core 332 is positioned further outward than the first magnets 334 in the radial direction. The first outer side core 332 includes a first outer side surface facing the stator 4. Like the first magnet 312 of the first example embodiment, the first outer side surface includes a first circular arc surface 332a and a second circular arc surface 332b. A central portion of the first outer side surface of the first outer side core 332 in a circumferential direction is a first top portion 332c.

The first rotor core 331 includes the first connection portion 331d configured to connect the first inner side core 331c and the first outer side core 332 between the first inner side core 331c and the first outer side core 332. The first connection portion 331d is positioned between the first magnets 334 arranged adjacent to each other in the circumferential direction.

The first rotor core 331 of the first rotating body 33 includes the first magnet 334 between the first inner side core 331c and the first outer side core 332. That is, the first rotor core 331 holds the first magnet 334. The first magnet 334 is in the state shown in FIG. 5 by being inserted into a through hole of the first rotor core 331 extending in the axial direction.

The first magnet 334 is a permanent magnet having a rectangular parallelepiped shape. Since the first magnet 334 has a rectangular parallelepiped shape, the first magnet 334 may be manufactured relatively easily and inexpensively than a magnet whose outer side surface is curved in a circular arc shape. Further, since it is not necessary to process surfaces of the magnet of the rectangular parallelepiped shape, the magnet may be manufactured with higher dimensional accuracy as compared with a case in which a plane surface is processed into a curved surface. Accordingly, a spacing distance between the rotor 3a and the stator 4 may be adjusted more accurately. Thus, variations in torque generated in the motor 1 including the rotor 3a may be suppressed.

The first circular arc surface 332a and the second circular arc surface 332b of the first outer side surface of the first outer side core 332 are curved in a circular arc shape when viewed in plan in a plane orthogonal to the axial direction. That is, the first circular arc surface 332a and the second circular arc surface 332b have a curved surface having a circular arc shaped cross-section. The first circular arc surface 332a and the second circular arc surface 332b have a first curvature radius R1 and a second curvature radius R2, respectively.

The second rotating body 34 has the same configuration as the first rotating body 33. A second outer side surface of a second outer side core 342 of the second rotating body 34 includes a third circular arc surface 342a and a fourth circular arc surface 342b. A central portion of the second outer side surface in the circumferential direction is a second top portion 342c.

The third circular arc surface 342a and the fourth circular arc surface 342b of the second outer side surface of the second outer side core 342 are curved in a circular arc shape when viewed in plan in a plane orthogonal to the axial direction. That is, the third circular arc surface 342a and the fourth circular arc surface 342b have a curved surface having a circular arc shaped cross-section. The third circular arc surface 342a and the fourth circular arc surface 342b have a third curvature radius R3 and a fourth curvature radius R4, respectively.

In the rotor 3a, the torque ripples generated while the motor 1 including the rotor 3a rotates may be reduced like in the rotor 3 even in the rotor 3a of the so-called IPM motor by making the curvature radii of the first circular arc surface 332a to the fourth circular arc surface 342b in the rotor 3a to have the same relationship as those of the rotor 3 of the example embodiment.

Further, positions of the first rotating body 33 and the second rotating body 34 are deviated from each other in the circumferential direction. Thus, as in the case of the rotor 3 of the example embodiment, cogging torque generated while the motor 1 including the rotor 3a rotates may be reduced.

The rotor 3 or 3a may have a configuration having three or more rotating bodies. In this case, a configuration is provided in which a third rotating body is further included in the axial direction in addition to the first rotating body and the second rotating body.

Although a configuration in which the first rotating body 31 and the second rotating body 32 are deviated from each other in the circumferential direction is adopted in the rotor 3 of the example embodiment, instead of the above configuration, a configuration may be provided in which positions of the first magnet 312 disposed on the outer circumferential surface of the first rotor core 311 and the second magnet 322 disposed on the outer circumferential surface of the second rotor core may be deviated from each other on one side and the other side in the circumferential direction, respectively. Even in this case, since the first outer side surface of the first magnet 312 and the second outer side surface of the second magnet 322 are deviated from each other in the circumferential direction, the cogging torque and the torque ripples may be reduced like in the configuration in which the first rotating body 31 and the second rotating body 32 are deviated from each other in the circumferential direction. In this case, a configuration may be provided in which one rotating body is included.

Further, although the rotor 3 of the example embodiment is illustrated with an example in which the first top portion 312c of the first magnet 312 and the second top portion 322c of the second magnet 322 are positioned at central portions in the circumferential direction, respectively, the positions of first top portion 312c and the second top portion 322c may not necessarily be limited to the central portions in the circumferential direction, but may be positions deviated in one direction or the other direction in the circumferential direction.

Heretofore, the specific description of the example embodiment and the modified examples of the present disclosure has been made. In the above description, the description is merely one example embodiment, and the scope of the present disclosure is not limited to the one example embodiment and may be broadly interpreted to a range that can be understood by those skilled in the art.

The present disclosure may be used for, for example, a motor mounted on a vehicle such as for electric power steering, a pump, a compressor, or the like.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-5 (canceled)

6. A rotor comprising:
a first rotating body; and
a second rotating body arranged along a central axis extending in a vertical direction; wherein
the first rotating body includes a first rotor core having a cylindrical shape with the central axis as a center thereof, a plurality of first magnets arranged in a circumferential direction, and a plurality of first outer side surfaces arranged in the circumferential direction;
each of the plurality of first outer side surfaces is an outer side surface of the first magnet or an outer side surface of the first rotor core, and includes a first circular arc surface curved in a circular arc shape with a first curvature radius in a plan view and arranged on one side in the circumferential direction and a second circular arc surface curved in a circular arc shape with a second curvature radius different from the first curvature radius in a plan view and arranged on the other side in the circumferential direction; and
the second rotating body is positioned on a side lower than the first rotating body in an axial direction, and includes a second rotor core having a cylindrical shape with the central axis as a center thereof, a plurality of second magnets arranged in the circumferential direction, and a plurality of second outer side surfaces arranged in the circumferential direction;
each of the plurality of second outer side surfaces is an outer side surface of the second magnet or an outer side surface of the second rotor core, and includes a third circular arc surface curved in a circular arc shape with a third curvature radius in a plan view and arranged on one side in the circumferential direction and a fourth circular arc surface curved in a circular arc shape with a fourth curvature radius different from the third curvature radius in a plan view and arranged on the other side in the circumferential direction.

7. The rotor of claim 6, wherein positions of the first rotating body and the second rotating body in the circumferential direction are deviated from each other.

8. The rotor of claim 6, wherein the second curvature radius is greater than the fourth curvature radius, and the third curvature radius is greater than the first curvature radius.

9. The rotor of claim 8, wherein the first curvature radius is the same as the fourth curvature radius, and the second curvature radius is the same as the third curvature radius.

10. A motor comprising:
a shaft, to which the rotor of claim 6 is attached, extending along the central axis in a vertical direction;
a bearing rotatably supporting the shaft;
a stator facing an outer side of the rotor in a radial direction; and
a housing accommodating the rotor and the stator; wherein
the first circular arc surface is one side in a circumferential direction with respect to the third circular arc surface, the first circular arc surface is one side in the circumferential direction with respect to the second circular arc surface, the fourth circular arc surface is the other side in the circumferential direction with respect to the third circular arc surface, and the first curvature radius and the fourth curvature radius are smaller than the second curvature radius and the third curvature radius.
